(19) United States
(12) Patent Application Publication
(10) Pub. No.: US 2025/0080363 A1
(43) Pub. Date: Mar. 6, 2025

(54) SECURE DEVICE REFERRAL TO SECOND ENVIRONMENT SYSTEM

(71) Applicant: Lenovo (United States) Inc., Morrisville, NC (US)

(72) Inventor: William Holroyd, Holly Springs, NC (US)

(21) Appl. No.: 18/456,996

(22) Filed: Aug. 28, 2023

(51) Int. Cl. H04L 9/32; H04L 9/30

(52) U.S. Cl. CPC H04L 9/3268; H04L 9/30

(57) ABSTRACT

One embodiment provides a method, the method including: receiving, from a device at a first environment system, an enterprise configuration request; verifying, at the first environment system, an identity of the device; identifying, at the first environment system, the device is assigned to a second environment system; and providing, at the first environment system, instructions for the device to access the second environment system, wherein the providing comprises providing encryption information to the device to verify the second environment system. Other aspects are claimed and described.

### BACKGROUND

When devices are purchased by users or other entities, the device will initially communicate with an environment to receive configuration information. The configuration information generally provides the device with all the information necessary to configure the device so that it has the latest software, firmware, can communication with a communications network, and/or the like. The configuration information may also include enterprise configuration information which includes any certificates and encryption information needed to connect to a network, server location, or other enterprise specific location and information regarding how to connect to the enterprise specific locations. For example, the information may include identification of endpoints for the enterprise specific locations. Once the device is configured, the device can connect to the enterprise specific locations.

### BRIEF SUMMARY

In summary, one aspect provides a method, the method including: receiving, from a device at a first environment system, an enterprise configuration request; verifying, at the first environment system, an identity of the device; identifying, at the first environment system, the device is assigned to a second environment system; and providing, at the first environment system, instructions for the device to access the second environment system, wherein the providing comprises providing encryption information to the device to verify the second environment system.

Another aspect provides an system, the system including: a processor; a memory device that stores instructions that, when executed by the processor, causes the system to: receive, from a device at a first environment system, an enterprise configuration request; verify, at the first environment system, an identity of the device; identify, at the first environment system, the device is assigned to a second environment system; and provide, at the first environment system, instructions for the device to access the second environment system, wherein the providing comprises providing encryption information to the device to verify the second environment system.

A further aspect provides a product, the product including: a computer-readable storage device that stores executable code that, when executed by a processor, causes the product to: receive, from a device at a first environment system, an enterprise configuration request; verify, at the first environment system, an identity of the device; identify, at the first environment system, the device is assigned to a second environment system; and provide, at the first environment system, instructions for the device to access the second environment system, wherein the providing comprises providing encryption information to the device to verify the second environment system.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for referring a device from a first environment system to a second environment system for enterprise configuration information for the device corresponding to the second environment system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The creation of enterprise configuration information that can be deployed when the device performs an initial configuration is referred to as a zero-touch configuration, meaning the enterprise does not have to touch the device in order for the device to properly communicate with the enterprise locations. The zero-touch configuration can be set up with a device when the device is manufactured. However, since the zero-touch configuration requires certificates and encryption information, the enterprise configuration information points to a server or network service provided by the manufacturer. This allows the manufacturer to create and store public and private keys associated with a device. The manufacturer can also provide the device with the appropriate keys, encryption information, and configuration information necessary to access the appropriate server or environment at the time of manufacture of the device.

While many enterprises or entities are comfortable with utilizing the server or network services of the manufacturer, referred to as the manufacturer environment, to support the enterprise, some enterprises prefer to use private servers or network services that are hosted by the enterprise or another entity. The utilization of a different server, network services, or other environment creates issues with the zero-touch configuration of the device. Specifically, the device has to be touched in order to make it communicate and access the desired environment instead of the manufacturer's designated environment, thereby negating the benefits of the zero-touch configuration. Currently there is no solution that allows for a zero-touch configuration to a different environment than that provided by the manufacturer.

In order to provide the zero-touch configuration to a different environment, the manufacturer would need private keys for each of the devices that would communicate with the different environment, also referred to as a second environment system or enterprise environment, from the enterprise. Since the provision of private keys for each of the devices to the manufacturer would expose the private keys to the manufacturer, an enterprise is unlikely to be willing to proceed with this method. Additionally, the enterprise would need to set up a public key as a pair to the private keys so that when the device accesses the enterprise environment, the enterprise environment could identify the device as a device that is or should be allowed to access the enterprise environment. This would require the enterprise to be intimately involved in the manufacturing of the devices and would also require the exposure of encryption information and configuration information of the enterprise to the manufacturer, thereby creating a security and privacy concern for the enterprise. Thus, the current solution for allowing a device to communicate with an enterprise environment instead of a manufacturer environment is that the enterprise must touch all the devices and configure the devices to communicate with the enterprise environment instead of the manufacturer environment.

Accordingly, the described system and method provides a technique for referring a device from a first environment system to a second environment system for enterprise configuration information for the device corresponding to the second environment system. In other words, the described system and method provides a technique that allows the manufacturer environment to refer the device to the enterprise environment for configuration information to access the enterprise environment while maintaining the zero-touch configuration method and maintaining the security and privacy of the enterprise. The first environment system, also referred to as the manufacturer server or environment for ease of readability, receives an enterprise configuration request from a device. The enterprise configuration request is a request made by the device requesting access to connect to and communicate with the manufacturer environment so as to receive additional configuration information. The enterprise configuration request may include information, for example, encryption information, device information, and/or the like, provided by the device in order to allow the manufacturer environment to validate the identity of the device.

Based upon the enterprise configuration request, the first environment system verifies the identity of the device. Specifically, the first environment system verifies that the device is a device that is authorized or expected to communicate with the first environment system. Additionally, the first environment system may identify that the device is assigned to a second environment system. Being assigned to a second environment system may include identifying the device has a status that indicates it corresponds to an enterprise or second environment different than the first environment. Upon successfully verifying the identity of the device and identifying the device is assigned to a second environment system, the first environment system provides instructions for the device to access the second environment system including provision of encryption information so that the device can verify the second environment system. In other words, the first environment system provides information to the device so the device knows how to access the second environment system and upon accessing the designated location, information that allows the device to validate the location corresponds to the second environment system. This information may include endpoint identification information, a public key corresponding to the second environment system, other configuration and/or encryption information, and/or the like.

Therefore, a system provides a technical improvement over traditional methods for configuring a device to access an environment system. By providing a technique for the first environment system to hand the device off to the second environment system, the described system and method provides a technique that still allows for the zero-touch configuration of a device while maintaining the security and privacy of the second environment. The first environment system can verify the identity of the device, thereby ensuring the device is one that is authorized to communicate with the first and second environment systems. Upon this verification, the first environment system can provide information to the device such that the device can access the second environment system and also ensure that the access point actually belongs to the second environment system. An additional layer of security allows the second environment system to also verify the identity of the device to prevent authorized access to the second environment system by devices that have swiped second environment system access information. Thus, the described system and method provides a technical improvement to conventional methods by allowing for the zero-touch configuration of devices even when the device will communicate with an environment different than the environment set up at the time of manufacture of the device.

The illustrated example embodiments will be best understood by reference to the figures. The following description is intended only by way of example, and simply illustrates certain example embodiments.

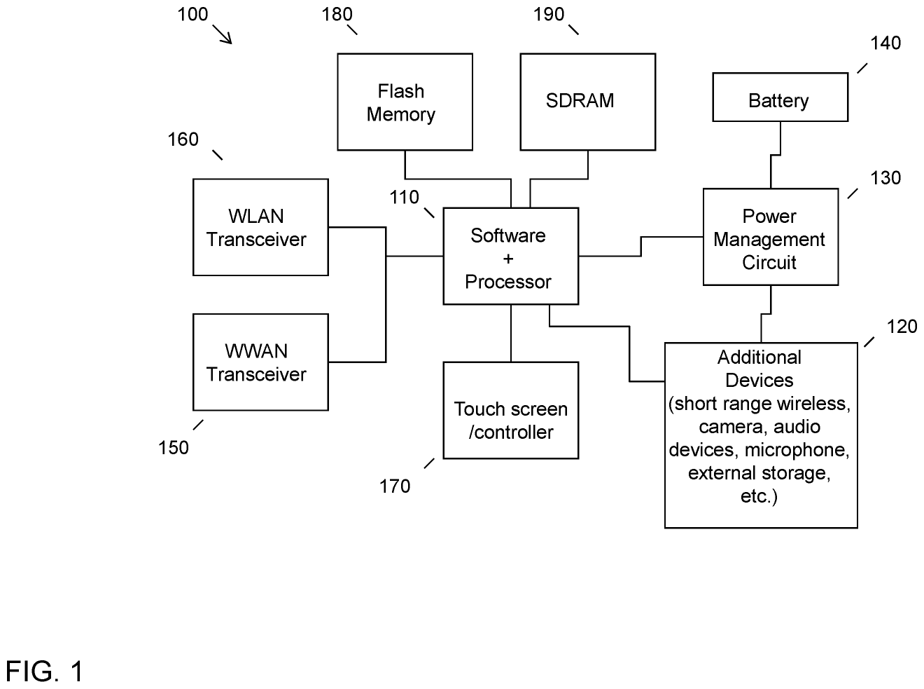

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

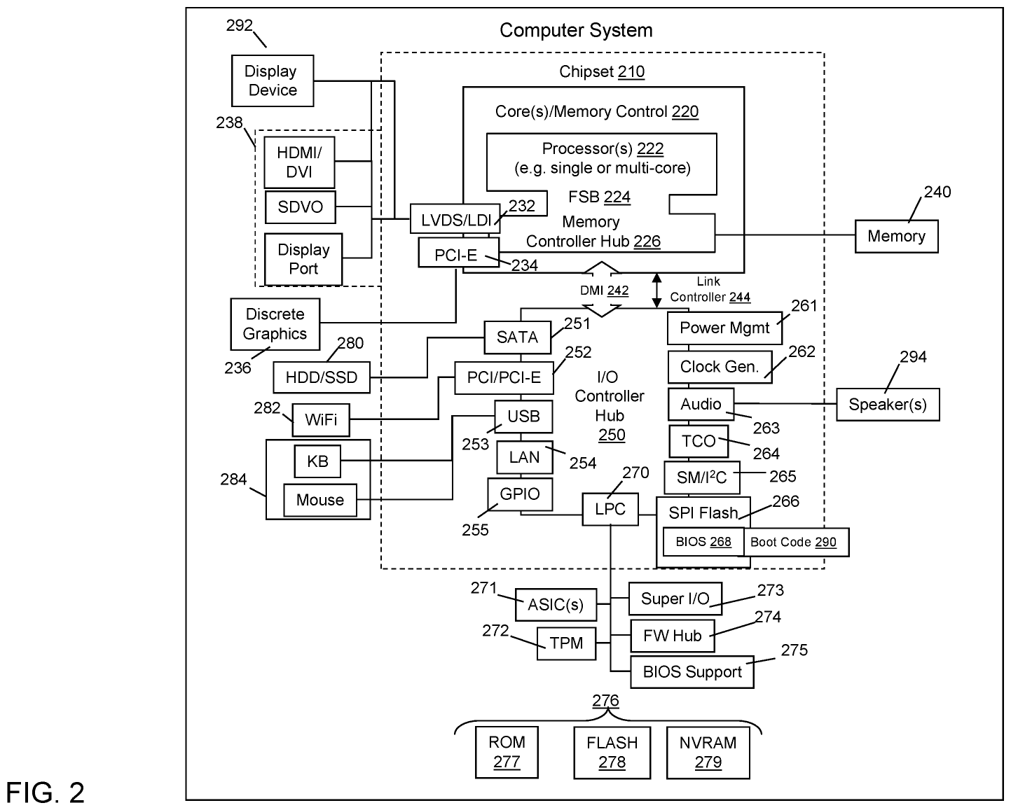

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in devices or systems that are set up for zero touch configuration, environments that communicate with devices, and/or the like. For example, the circuitry outlined in FIG. 1 may be implemented in a tablet or smart phone embodiment, whereas the circuitry outlined in FIG. 2 may be implemented in a personal computer embodiment.

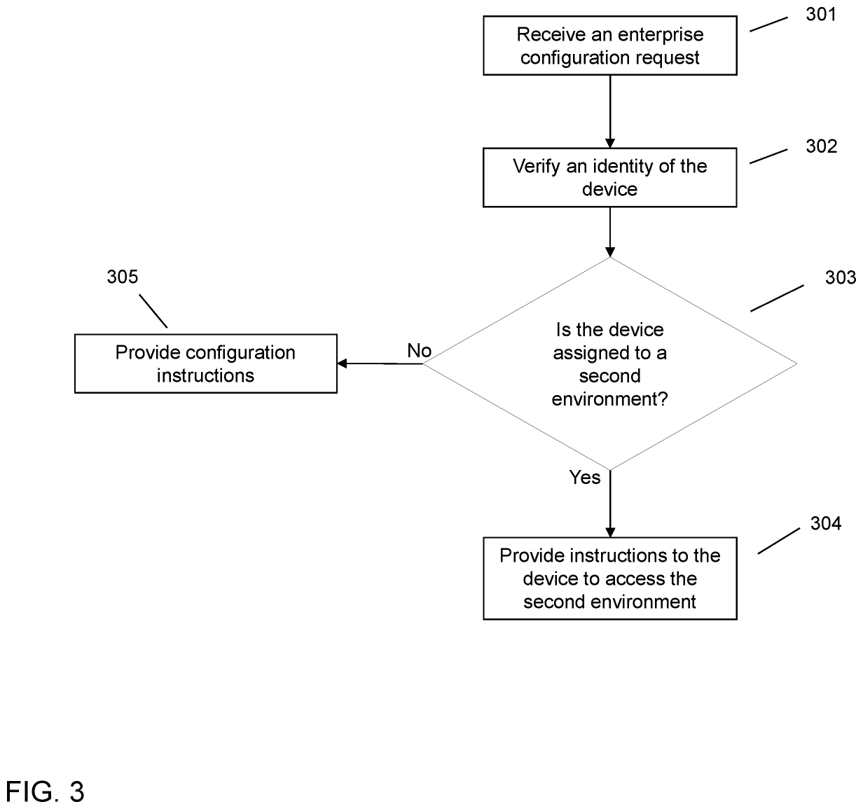

FIG. 3 illustrates an example method for referring a device from a first environment system to a second environment system for enterprise configuration information for the device corresponding to the second environment system. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to refer devices from one environment to a second environment to obtain configuration information for the device from the second environment. Additionally, the secure device referral system includes modules and features that are unique to the described system.

The secure device referral system facilitates communication between three entities, the device, the first environment, and the second environment. For ease of readability, the first environment will be referred to as the manufacturer environment and the second environment will be referred to as an enterprise environment. This is because the most common configuration of the system will likely be the hand off of the device from the manufacturer environment to an environment associated with an enterprise or other entity. However, this is not intended to limit the scope of this disclosure thereto as other possible environments can be utilized. The device may be any type of device that has the capability to communicate with different environments. Thus, the device may be a portable information handling device (e.g., smart phone, tablet, laptop computer, virtual reality headset, augmented reality headset, smart watch, etc.) a stand-alone user device (e.g., desktop computer, smart appliance, smart television, etc.), an entity component or device (e.g., server, router, network access point, etc.), and/or any other device, system, and/or component with communication capabilities.

For example, the second environment may be another environment associated with the manufacturer different than the default environment. As an example, a manufacturer may have two cloud service environments that run independently from each other. While a device may be manufactured with a default to communicate with the first cloud service environment, the manufacturer may want to transfer that communication to the second cloud service environment. The described system and method could be used to facilitate such a transfer. It is also noted that while the majority of this disclosure discusses an initial configuration of the device being transferred to a second environment, the disclosed technique can also be applied to transfer the device to the second environment at any time during the life of the device. For example, the device may operate on and communicate with the first environment for days, months, or even years, before being transferred to a second environment. In this case, upon the next communication of the device to the first environment, the first environment could provide the instructions and other necessary information to the device to connect to the second environment.

The first environment system and/or second environment system may be networks, services, and/or other environments of the associated entity. The main example used here throughout will be that the first environment system and second environment systems are servers associated with cloud services. However, this is not intended to limit the scope of the disclosure to solely cloud services. Other possible environments include entity networks, Internet or Intranet sites, network servers or other network components, data storage locations, and/or the like. Thus, the term “server” is not intended to limit the scope of the disclosure to solely servers as other components or services may be utilized.

The described system can be somewhat configurable by the second environment entity. Specifically, some of the security measures that are selected and utilized may be chosen by the second environment entity. As an example, the second environment entity may choose to create a certificate and provide the public key to the first environment system instead of the first environment system generating the public key. As another example, the second environment system may choose to verify the identity of the device when the device accesses the second environment system. Thus, different entities that communicate with the manufacturer may have different hand off policies that are implemented at the manufacturer or device originator. Regardless of these selections, the described technique still allows for the handoff of the device to the second environment system while maintaining the desired security and privacy of the entity.

When a device is manufactured, the device may include instructions that inform the device to contact a particular location upon boot up or an initialization. Generally, this may be the manufacturer's environment. However, this may be a different environment. For example, a device may be programmed by a retailer to access a retailer environment upon initialization or boot up. Alternatively, the device may have installed software or hardware components that override any manufacturer programming. For example, a subscriber identity module (SIM) card may be installed in a device that instructs the device to connect to a retailer environment instead of a manufacturer environment. Thus, while the majority of this disclosure will discuss the manufacturer environment as the first environment system, it should be noted that this may not be the manufacturer environment, but rather some initial environment programmed to the device.

The device may also include a certificate that is embedded in a secure enclave of the device, for example, a TPM, a secure enclave chip other than a TPM, a secure firmware location, or other secure enclave. Thus, there is a private key stored on the device. The private key is part of a public/private key-pair encryption set. The corresponding public key is stored at the first environment system. Thus, when the device accesses the first environment system, the device can communicate with the first environment system utilizing the public/private key-pair.

In the event that the device does not have a secure enclave for storage of a private key or the entity hosting the first environment system is unable to assign private keys to all the devices, the device may have software that is installed on the device. The software may have a built-in signed certificate that includes a signature generated from the first environment system. Upon accessing the first environment system, the device can verify the first environment system by comparing signatures received from the first environment system with the signature of the signed certificate to verify the communications are occurring with the expected entity.

At 301, the first environment system may receive an enterprise configuration request from a device. When a device is initialized or booted for the first time, the device is programmed with instructions to access a particular environment to receive configuration instructions. Thus, the device executes these instructions and accesses the environment that is provided in the instructions. This environment is the first environment system. Thus, the first environment may also be called the initial environment or initial configuration environment.

The device accesses the first environment in order to receive instructions regarding the configuration of the device. It may also receive additional information including encryption information (e.g., public and/or private keys, certificates, etc.), firmware and/or software updates or configurations, access points identifications, and/or the like. The request presented by the device to receive the instructions regarding the configuration of the device is referred to as an enterprise configuration request. Thus, the enterprise configuration request may be a request presented by a device requesting instructions regarding how the device should be configured. The enterprise configuration request may be a zero-touch configuration request that causes the device to automatically request the device configuration information for accessing an enterprise without requiring a user to provide input to the device to obtain the configuration information or provide instructions to obtain the configuration information.

When presenting the enterprise configuration request to the first environment, the device may also provide additional information regarding the device. The additional information may include information that allows the first environment to verify the identity of the device at 302. Thus, the additional information may include device identifiers (e.g., asset number, serial number, identification number, model, device type, manufacturer, etc.), cryptographic information (e.g., private key, public key, certificate, etc.), and/or the like. The first environment may access a database or other data store that includes a set of device identifiers. The device identifiers of the data store may correspond to devices that are authorized to access the first environment. Thus, a match between the device-provided device identifiers and a device identifier included in the data store may provide an indication that the device is authorized to access the first environment.

If the device includes a secure enclave having a private key, when the device accesses the first environment, the first environment may verify the device identity using the public key held by the first environment against the private key of the device. At a high level this generally means that when the device accesses the first environment, the first environment provides a message to the device that has been encrypted using the public key of the first environment. The device receives the message and decrypts the message using the private key of the device, where the private key is paired to the public key. Upon decryption of the message, the decrypted message is compared to an expected message and a match between the decrypted message and the expected message indicates a successful verification of the identity of the device with respect to the first environment. Thus, the device can be assured that it is communicating with the expected environment and the environment can verify the identity of the device.

If the device does not have a private key and instead has software including a signed certificate, when the device receives information back from the first environment the first environment will sign the information. The signing of the information may occur regardless of what device verification technique is utilized. In other words, the first environment may sign all communications from the first environment regardless of whether the signatures are being utilized to verify the identity of the device. The signature is encrypted using a private key of the first environment. The device has the corresponding public key. The device can utilize the public key to verify that the signature included on the message or information received from the first environment matches the signature of the signed certificate included in the software, thereby allowing the device to validate the identity of the first environment and ensure that messages from the environment are messages being sent from the expected environment.

The device identity verification allows the first environment to ensure that the device that is communicating with the first environment is authorized to receive instructions from the first environment. This provides a level of security regarding the device. Additionally, since the device identity has been verified, the first environment can be ensured that it is providing instructions to a device that should receive such instructions. Thus, this provides a level of security to ensure that messages from the first environment are only provided to authorized devices.

The first environment server may identify if the device is assigned to a second environment system at 303. It should be noted that this identification may occur before the device identity verification, simultaneously with the device identity verification, and/or after the device identity verification. Identifying the device is assigned to a second environment includes determining whether the device is somehow marked as belonging to or assigned to another environment. One technique for assigning a device to a second environment is that the device may be a device that has been sold to a particular entity or organization. These types of devices can be pre-registered to an organization such that the organization, entity, or other enterprise only has to accept the device or adopt the device into the enterprise. The pre-registration can occur on the device itself which means that when the device communicates to the first environment it provides identification that it is pre-registered to a particular enterprise.

The pre-registration or marking may also occur in a data store, which may be the same data store discussed in connection with the device identity verification, where the device identifier is associated with a marking, status, or other identifier indicating the device is associated with the enterprise. Thus, when the first environment verifies the identity of the device or otherwise accesses the data store corresponding to the device identifier, the first environment can be apprised of the assignment or status of the device as being assigned to the second environment. For example, the device may have a ready to adopt status, a pending against an enterprise status, and/or the like.

The manufacturer or device initiator may also make assignments of devices to a second environment. For example, an entity or organization may request or buy a certain number of devices. The manufacturer at the time of manufacture may assign a batch of devices to that entity. This assignment may be based upon a device identifier and may be stored within the data store. Thus, when the device accesses or communicates with the first environment, the first environment and device are apprised of the assignment status.

To identify the correct second environment, the system may identify the entity to which the device is assigned and then identify the second environment corresponding to that entity. In other words, the system can identify the device is assigned to an environment other than the first environment and to identify the correct second environment, the system may identify the entity and the second environment can be established as the environment that is hosted by the entity or otherwise designated by the entity.

If the first environment determines that the device has not been assigned to a second environment at 303, the first environment may provide, at 305, the device with the enterprise registration information to fulfill the enterprise configuration request that was received at 301. In other words, the first environment provides configuration instructions to the device so that the device will continue to communicate with the first environment unless or until the device is assigned to a new environment. Thus, if the device has not been assigned to a second environment, the device will be configured through traditional zero touch configuration techniques.

On the other hand, if the first environment determines that the device has been assigned to a second environment at 303, the first environment provides instructions to the device to access the second environment at 304. This provision of instructions to access the second environment is also referred to as a hand off or referral of the device to the second environment. The instructions provide an indication of how the device can access the second environment. For example, the instructions may indicate an endpoint or other access point that can be utilized to access the second environment. The endpoint may be one that has been previously provisioned by the second environment and indicated to the first environment so as to allow the first environment to provide proper instructions to the device(s) that need to be handed off to the second environment.

However, since endpoints can change, be attacked or taken over, and/or the like, the hand off technique may include additional information so as to ensure that the device accesses the expected second environment. Thus, provision of the instructions may also include providing encryption information to the device to allow the device to verify the second environment. The encryption information may include a certificate, a public key, a private key, a hash, or other cryptographic element. The provided encryption information is keyed to the second environment, meaning that the provided encryption information is a pair to encryption information of the second environment, correctly decrypts information provided by the second environment, and/or the like. Thus, when the device accesses the second environment, the encryption information can be utilized by the device to verify that the environment being accessed is actually the second environment or expected environment.

As one example, the first environment may provide, once the first environment has verified the identity of the device, the device with a certificate that matches or is a paired to a public key held by the second environment. When the device accesses the second environment, the device can request a public key from the second environment. Alternatively, the second environment may provide the public key to the device when it accesses the second environment. The device can then determine if the key provided by the second environment is a pair to the encryption information contained within the certificate. This matching and comparing may be performed by encrypting or decrypting messages utilizing the certification and/or the public key and then determining if the message is an expected message either via matching messages or by reading the message and identifying particular information contained within the message. Upon determining the encryption information provided by the second environment is the expected information, the device can be assured that the accessed environment is the second environment.

As another example, the second environment can create a certificate and provide the public key to the first environment. The second environment then holds the certificate and, therefore, the private key. When the device accesses the first environment, the first environment provides the public key to the device once the identity of the device has been verified by the first environment. The device then accesses the second environment utilizing the information provided by the first environment. The device and second environment communicate to verify the public key held by the device against the certificate held by the second environment. Upon a successful match, the device is assured that the second environment is the correct environment and the second environment can be assured that the first environment sent the device to the second environment.

Another technique to verify that the first environment sent the device to the second environment is based upon a signature of the first environment. When the first environment provides the instructions to the device for accessing the second environment, the first environment may sign the instructions with a signature corresponding to the first environment. Not only can the device verify the signature matches a signature known to originate from the first environment, but the signature can also be utilized by the second environment to verify the instructions were provided to the device from the first environment. When the device accesses the second environment, the second environment can verify the signature on the instructions with a signature known to originate from the first environment. A match indicates that the instructions were indeed provided by the first environment.

In addition to verifying the first environment transferred or sent the device to the second environment, the second environment may also verify that the device is expected at the second environment. The first environment may provide a list of devices that will be transferred to the second environment. This list may include identification information that the second environment can utilize to verify that the device is an expected device. Additionally, just like the first environment can verify the identity of the device, the second environment can perform the same verification. In this case, the first environment can provide the public key that corresponds to the devices to the second environment. The second environment can then utilize the public key in the same way that the first environment did to verify the identity of the device.

The referral to the second environment may occur in response to different triggers. In one scenario the devices may be registered to a particular entity or environment. When the devices are initialized, the device may access the first environment and when the first environment sees the device is assigned to a second environment, the first environment provides the transfer instructions to the device. Once the device accesses the second environment, the second environment may determine whether to accept the device and provide configuration instructions to the device for accessing the second environment.

In another scenario, the device may access the first environment and the first environment may see that the device has a status indicating it is to be assigned to a second environment. However, instead of immediately transferring the device to the second environment, the first environment may wait to receive instructions from the second environment indicating the second environment is ready for the device. Upon receipt of these instructions, the first environment may then provide instructions to the device for the transference of the device to the second environment.

Once transferred to the second environment, the second environment can choose to accept the device into the second environment or the second environment may be set to automatically accept devices that pass the security measures. Once the transfer is made, the second environment provides the enterprise configuration instructions to the device so that the device can be configured to communicate with the second environment. Thus, once the transfer has been made to the second environment, the device can be configured utilizing the zero touch configuration techniques. In other words, once the device has been transferred and accepted by the second environment, the device can be configured like in traditional configuration techniques.

While the disclosure is written from the perspective of the first environment system, it is worth noting that corresponding steps are undertaken by the other devices within the communication system. For example, from the device perspective, the device would present an enterprise configuration request to the first environment system. The device may also present any other necessary information, for example, a private key, device identification information, and/or the like. Once the first environment device verifies the identity of the device and determines it is assigned to a second environment system, the device receives instructions from the first environment system that identifies a location to access and information needed to access the location.

The device then accesses the identified location and presents the necessary information. Alternatively, the device may access the identified location and receive information from the second environment system. The device can then use the received information to verify the identity of the second environment system. Once the second environment system authorizes the device to access the second environment system based upon communications between the second environment system and the device, the device can then access the second environment system, receive the enterprise configuration information from the second environment system, and will continue to access and communicate with the second environment system instead of the first environment system due to the enterprise configuration information received from the second environment system.

From the second environment system perspective, the second environment system will receive a request from a device to access the second environment system. The second environment system will request encryption information from the device or receive the encryption information from the device. The encryption information provided by the device was received from the first environment system. The encryption information obtained by the second environment system indicates that the first environment system verified the identity of the device and sent the device to the second environment system. The second environment system communicates with the device and upon completion of the communications and validation that the device is authorized to access the second environment system, the second environment system will provide enterprise configuration information to the device so that the device will be configured to communicate with the second environment system. The second environment system may also perform additional steps of validating the identity of the device to ensure that the device was expected by the second environment system.

Thus, the described system and method provides a technique that allows a hand off of a device from a first environment to a second environment. The device may be preconfigured, either during manufacturing or through programming, to access the first environment to set up a zero touch configuration for the device. However, an entity may want the device to be configured to access and communicate with the second environment instead of the first environment. When the device accesses the first environment, the first environment can perform some initial steps so as to validate the device and then provide the device instructions to access the second environment for the configuration instructions, where the configuration instructions will cause the device to no longer communicate with the first environment and instead communicate with the second environment.

Upon accessing the second environment, the device will be able to verify the second environment is the correct environment and the second environment can verify the device. Once the second environment allows access to the device, the second environment can provide the configuration instructions to the device. Thus, the described system and method provides for a secure method for handing off a device from a first environment to a second environment that allows for the device to be configured without the entity associated with the second environment having to touch the device, thereby providing the zero-touch configuration for the device while allowing an entity to select the desired environment that the device will communicate with.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, from a device at a first environment system, an enterprise configuration request;
verifying, at the first environment system, an identity of the device;
identifying, at the first environment system, the device is assigned to a second environment system; and
providing, at the first environment system, instructions for the device to access the second environment system, wherein the providing comprises providing encryption information to the device to verify the second environment system.

2. The method of claim 1, wherein the providing encryption information comprises providing a public key that the device presents at the second environment system that the second environment system utilizes to verify the device.

3. The method of claim 2, wherein the public key comprises a public key provided to the first environment system from the second environment system and corresponds to a private key held by the second environment system.

4. The method of claim 1, wherein the providing encryption information comprises providing an encryption certificate that the device presents at the second environment system to verify encryption information provided by the second environment system in response to the encryption certificate.

5. The method of claim 1, wherein the identifying comprises identifying the device is assigned, within a database accessible by the first environment system, to an entity hosting the second environment system.

6. The method of claim 1, wherein the verifying comprises validating the device using a public key of the first environment system against a private key stored within the device.

7. The method of claim 1, wherein the providing instructions comprises providing, from the first environment system, signed metadata indicating an endpoint of the second environment system;
wherein the signed metadata is signed by the first environment system utilizing a private key of the first environment system;
wherein the device verifies a signature of the signed metadata against a signature certificate stored on the device and generated utilizing the private key of the first environment system.

8. The method of claim 1, wherein the providing instructions comprises identifying an endpoint corresponding to the second environment system.

9. The method of claim 1, wherein the receiving an enterprise configuration request comprises receiving a zero-touch configuration request.

10. The method of claim 1, wherein the first environment system and the second environment system comprise cloud service providers.

11. A system, the system comprising:
a processor;
a memory device that stores instructions that, when executed by the processor, causes the system to:
receive, from a device at a first environment system, an enterprise configuration request;
verify, at the first environment system, an identity of the device;
identify, at the first environment system, the device is assigned to a second environment system; and
provide, at the first environment system, instructions for the device to access the second environment system, wherein the providing comprises providing encryption information to the device to verify the second environment system.

12. The system of claim 11, wherein the providing encryption information comprises providing a public key that the device presents at the second environment system that the second environment system utilizes to verify the device.

13. The system of claim 12, wherein the public key comprises a public key provided to the first environment system from the second environment system and corresponds to a private key held by the second environment system.

14. The system of claim 11, wherein the providing encryption information comprises providing an encryption certificate that the device presents at the second environment system to verify encryption information provided by the second environment system in response to the encryption certificate.

15. The system of claim 11, wherein the identifying comprises identifying the device is assigned, within a database accessible by the first environment system, to an entity hosting the second environment system.

16. The system of claim 11, wherein the verifying comprises validating the device using a public key of the first environment system against a private key stored within the device.

17. The system of claim 11, wherein the providing instructions comprises providing, from the first environment system, signed metadata indicating an endpoint of the second environment system;
wherein the signed metadata is signed by the first environment system utilizing a private key of the first environment system;
wherein the device verifies a signature of the signed metadata against a signature certificate stored on the device and generated utilizing the private key of the first environment system.

18. The system of claim 11, wherein the providing instructions comprises identifying an endpoint corresponding to the second environment system.

19. The system of claim 11, wherein the receiving an enterprise configuration request comprises receiving a zero-touch configuration request.

20. A product, the product comprising:
a computer-readable storage device that stores executable code that, when executed by a processor, causes the product to:
receive, from a device at a first environment system, an enterprise configuration request;
verify, at the first environment system, an identity of the device;
identify, at the first environment system, the device is assigned to a second environment system; and
provide, at the first environment system, instructions for the device to access the second environment system, wherein the providing comprises providing encryption information to the device to verify the second environment system.
